(19) United States
(12) Patent Application Publication
(10) Pub. No.: US 2012/0092888 A1
(43) Pub. Date: Apr. 19, 2012

(54) EDGE LIGHTING BACK LIGHT MODULE

(76) Inventor: Chih-Chin Hsieh, Hsin-Chu (TW)

(21) Appl. No.: 13/009,859

(22) Filed: Jan. 20, 2011

(30) Foreign Application Priority Data
Oct. 15, 2010 (TW) 099135194

(51) Int. Cl. F21V 8/00

(52) U.S. Cl. 362/606; 362/613; 362/612

(57) ABSTRACT

An edge lighting back light module includes a first light guide plate, at least one second light guide plate, and a plurality of light emitting devices. The first light guide plate has a light incident plane with a first thickness. The second light guide plate has a light incident plane and a light exit plane. The light exit plane of the second light guide plate faces the light incident plane of the first light guide plate, and the light exit plane of the second light guide plate has a second thickness smaller than the first thickness of the light incident plane of the first light guide plate. The light emitting devices face the light incident plane of the second light guide plate.

### BACKGROUND OF THE INVENTION

1. Field of the Invention

The present invention relates to an edge lighting back light module, and more particularly, to an edge lighting back light module with high light utilization efficiency.

2. Description of the Prior Art

Nowadays, liquid crystal display (LCD) devices and a variety of electronic products equipped with LCD panels, such as cell phones, laptops, etc., are designed toward the trend of ultra-thin configurations. In order to decrease the volumes of back light modules, light emitting diodes (LEDs) have gradually replaced cold cathode fluorescent lamps (CCFLs) to serve as light source generators to provide back light sources. In an edge lighting back light module, LEDs are disposed on an edge of the back light module, and therefore fewer LEDs are required and a thinner thickness design can be fulfilled.

Please refer to FIG. 1, which schematically illustrates a conventional edge lighting back light module. As shown in FIG. 1, the conventional edge lighting back light module 10 includes a light guide plate 12, and a plurality of LEDs 14 disposed on an edge of the light guide plate 12. The LEDs 14 emit light sources toward the light guide plate 12, and the light guide plate 12 is able to scatter the incident light sources evenly, and guide the light sources toward an LCD panel (not shown) to provide back light sources for the LCD panel. The light emitted from the LEDs 14 (as shown by the arrows in FIG. 1) will pass the air and enter the light guide plate 12; however, since the refractive index of the light guide plate 12 is larger than that of the air, when entering the light guide plate 12 from the air, the light emitted from the LEDs 14 will be converged inwardly by refraction due to the variation of refractive indices. Consequently, bright regions would appear at specific locations of the light guide plate 12, which correspond to the positions where LEDs 14 are disposed, while dark regions would appear at the locations of light guide plate 12, which correspond to the positions where no LEDs 14 are disposed. As a result, the light sources provided by the conventional edge lighting back light module 10 may lead to bright and dark inclined stripes with alternate arrangement, which is known as hot spot problem. The hot spot problem needs to be improved, and the light utilization efficiency of the conventional edge lighting back light module needs to be further enhanced as well.

### SUMMARY OF THE INVENTION

It is therefore one of the objectives of the present invention to provide an edge lighting back light module to solve the hot spot problem, and to enhance light utilization efficiency.

According to a preferred embodiment of the present invention, an edge lighting back light module includes a first light guide plate, at least one second light guide plate, and a plurality of light emitting devices. The first light guide plate includes at least one light incident plane, and the light incident plane of the first light guide plate has a first thickness. The second light guide plate includes a light incident plane and a light exit plane, and the light exit plane of the second light guide plate and the light incident plane of the first light guide plate face each other. Also, the light exit plane of the second light guide plate has a second thickness, and the second thickness of the light exit plane of the second light guide plate is substantially smaller than the first thickness of the light incident plane of the first light guide plate. Additionally, the light emitting devices face the light incident plane of the second light guide plate.

In the edge lighting back light module of the present invention, the thickness of the light exit plane of the second light guide plate is smaller than that of the light incident plane of the first light guide plate, and the light exit plane of the second light guide plate can be completely covered by the light incident plane of the first light guide plate. As a result, the light utilization efficiency can be effectively enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional edge lighting back light module.

FIG. 2 and FIG. 3 are schematic diagrams illustrating an edge lighting back light module according to a first preferred embodiment of the present invention.

FIG. 4 is a schematic diagram illustrating an edge lighting back light module according to a second preferred embodiment of the present invention.

FIG. 5 is a schematic diagram illustrating an edge lighting back light module according to a third preferred embodiment of the present invention.

FIG. 6 is a schematic diagram illustrating an edge lighting back light module according to a fourth preferred embodiment of the present invention.

FIG. 7 is a schematic diagram illustrating an edge lighting back light module according to a fifth preferred embodiment of the present invention.

FIG. 8 is a schematic diagram illustrating an edge lighting back light module according to a sixth preferred embodiment of the present invention.

FIG. 9A and FIG. 9B are schematic diagrams illustrating a second light guide plate according to a preferred embodiment of the present invention.

FIG. 10 is a schematic diagram illustrating a second light guide plate according to another preferred embodiment of the present invention.

FIG. 11 is a schematic diagram illustrating a variety of microstructures according to a preferred embodiment of the present invention.

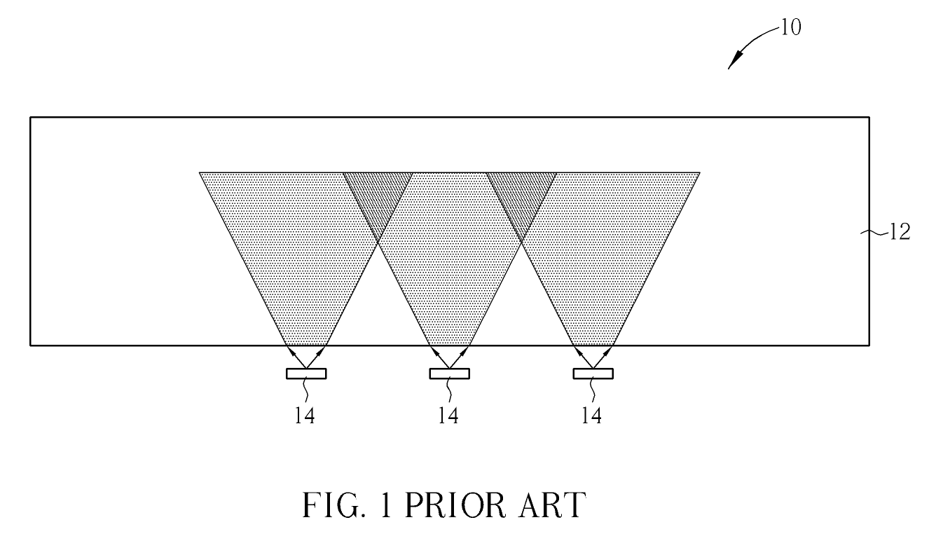

### DETAILED DESCRIPTION

To provide a better understanding of the presented invention for one skilled in the art, preferred embodiments will be detailed as follows. The preferred embodiments of the present invention are illustrated in the accompanying drawings with numbered elements to elaborate the contents and effects to be achieved.

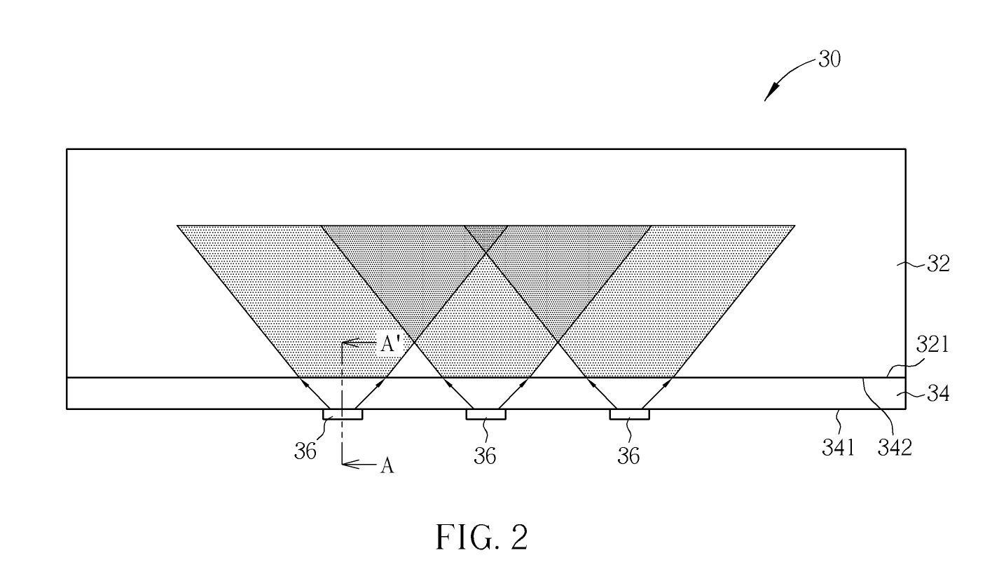

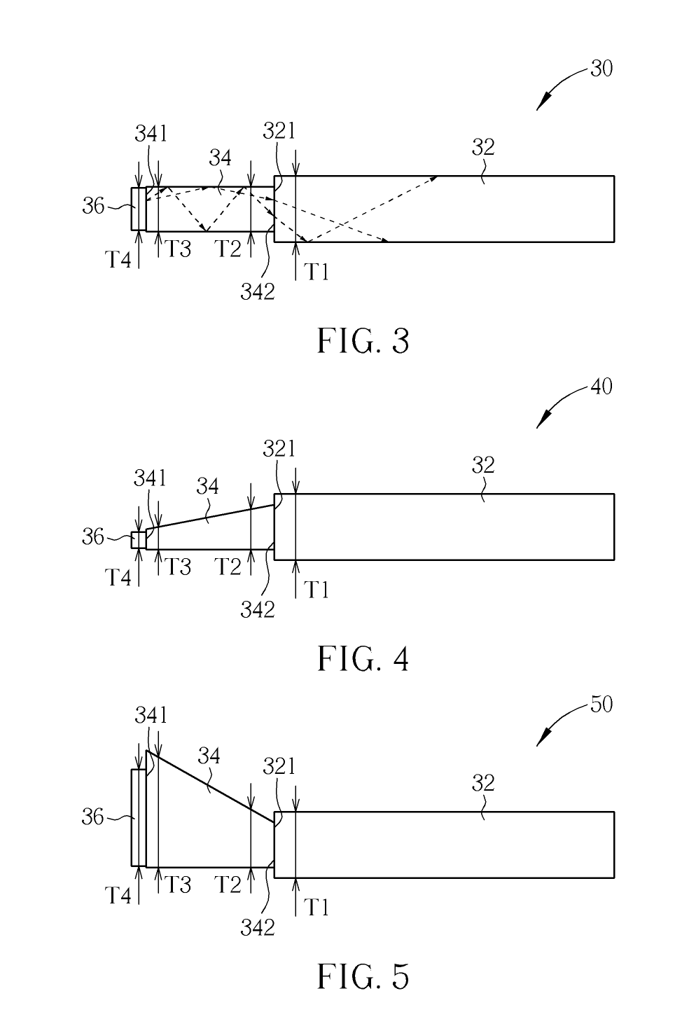

Please refer to FIG. 2 and FIG. 3, which schematically illustrate an edge lighting back light module according to a first preferred embodiment of the present invention. FIG. 2 is a top view diagram of the edge lighting back light module according to this embodiment, and FIG. 3 is a cross-sectional view diagram of the edge lighting back light module taken along a line A-A′ of FIG. 2. As shown in FIG. 2 and FIG. 3, the edge lighting back light module 30 according to the preferred embodiment includes a first light guide plate 32, at least one second light guide plate 34, and a plurality of light emitting devices 36. The first light guide plate 32 has at least one light incident plane 321, and the light incident plane 321 of the first light guide plate 32 has a first thickness T1 (as shown in FIG. 3). The second light guide plate 34 has a light incident plane 341 and a light exit plane 342, and the light exit plane 342 of the second light guide plate 34 and the light incident plane 321 of the first light guide plate 32 face each other. Moreover, the light exit plane 342 of the second light guide plate 34 has a second thickness T2 (as shown in FIG. 3), and the second thickness T2 of the light exit plane 342 of the second light guide plate 34 is substantially smaller than the first thickness T1 of the light incident plane 321 of the first light guide plate 32. The light emitting devices 36 face the light incident plane 341 of the second light guide plate 34. In accordance with the embodiment, the second light guide plate 34 is located at one side of the first light guide plate 32, but not limited thereto. In consideration of different requirements such as the size of the first light guide plate 32, the light-emitting efficiency of the light emitting devices 36, and the brightness specification of LCD panels, the second light guide plates 34 may be located at two sides, three sides or four sides of the first light guide plate 32, and also the number and the locations of the light emitting devices 36 could be adjusted. Additionally, the light emitting devices 36 may be LEDs, but not limited thereto. For example, the light emitting devices 36 may be other kinds of light emitting devices.

As shown in FIG. 3, the second thickness T2 of the light exit plane 342 of the second light guide plate 34 is substantially smaller than the first thickness T1 of the light incident plane 321 of the first light guide plate 32. Thus, even when misalignment due to variation of the assembling processes of the first light guide plate 32 and the second light guide plate 34 occurs, it still can be ensured that the light exit plane 342 of the second light guide plate 34 is completely covered within the range of the light incident plane 321 of the first light guide plate 32, and thus the light emitted from the light exit plane 342 of the second light guide plate 34 can completely enter the light incident plane 321 of the first light guide plate 32 without energy loss. In the present embodiment, the first thickness T1 may be 2 micrometer (mm), and the second thickness T2 may be 1.5 mm, for example, but not limited thereto. Moreover, to ensure that light beams emitted from the light emitting devices 36 can thoroughly enter the light incident plane 341 of the second light guide plate 34, the light incident plane 341 of the second light guide plate 34 has a third thickness T3, and the light emitting device 36 has a fourth thickness T4, and the fourth thickness T4 of the light emitting device 36 is substantially smaller than the third thickness T3 of the light incident plane 341 of the second light guide plate 34. Accordingly, even when misalignment due to variation of the assembling processes of the light emitting devices 36 and the second light guide plate 34 occurs, it still can be ensured that the light emitting devices 36 are completely covered within the range of the light incident plane 341 of the second light guide plate 34 without energy loss. It is noted that the thickness difference between the second thickness T2 and the first thickness T1, as well as the thickness difference between the fourth thickness T4 and the third thickness T3 could be adjusted according to assembling tolerance or other considerations, instead of being a fixed value. Additionally, the first light guide plate 32 and the second light guide plate 34 could be made of either identical or different materials, and the refractive indices of the first light guide plate 32 and the second light guide plate 34 could be the same, for example, the first light guide plate 32 and the second light guide plate 34 may have the same refractive index of 1.5, but not limited thereto. The refractive indices of the first light guide plate 32 and the second light guide plate 34 also could be different. It is appreciated that the refractive indices of the first light guide plate 32 and the second light guide plate 34 are preferably larger than that of the medium which is in contact with the first light guide plate 32 and the second light guide plate 34, such as the air. Accordingly, total internal reflection inside the first light guide plate 32 and the second light guide plate 34 may be conducted, and thus the light utilization efficiency can be improved.

In order to enhance the light utilization of efficiency, the light exit plane 342 of the second light guide plate 34 and the light incident plane 321 of the first light guide plate 32 are preferably in contact with each other directly, and also the light emitting devices 36 and the light incident plane 341 of the second light guide plate 34 are preferably in contact with each other directly in this embodiment, but not limited thereto. Moreover, the cross-section shape of the second light guide plate 34 is a rectangle shape, but not limited thereto, and the second thickness T2 of the light exit plane 342 is substantially equal to the third thickness T3 of the light incident plane 341 of the second light guide plate 34. Furthermore, when viewing from top, the second light guide plate 34 has a bar-shaped structure, and the plurality of the light emitting devices 36 correspond to different positions of the second light guide plate 34 (as shown in FIG. 2). In other words, each second light guide plate 34 corresponds to a plurality of the light emitting devices 36, but not limited thereto. For example, the number of the second light guide plates 34 may be identical to that of the light emitting devices 36.

The edge lighting back light module of the present invention is not limited to the embodiment which is previously mentioned. The following descriptions will introduce the edge lighting back light modules according to other preferred embodiments. For the sake of clear comparison between different embodiments, identical components are denoted by identical numerals. In addition, the description focuses on the differences between embodiments, and repeated aspects are not redundantly described.

Please refer to FIG. 4, which schematically illustrates an edge lighting back light module according to a second preferred embodiment of the present invention. As shown in FIG. 4, in accordance with this embodiment, the cross-section shape of the second light guide plate 34 of the edge lighting back light module 40 is a trapezoid shape, where the second thickness T2 of the light exit plane 342 of the second light guide plate 34 is substantially smaller than the first thickness T1 of the light incident plane 321 of the first light guide plate 32, and the second thickness T2 of the light exit plane 342 of the second light guide plate 34 is substantially larger than the third thickness T3 of the light incident plane 341.

Please refer to FIG. 5, which schematically illustrates an edge lighting back light module according to a third preferred embodiment of the present invention. As shown in FIG. 5, in this embodiment, the cross-section shape of the second light guide plate 34 of the edge lighting back light module 50 is a trapezoid shape, where the second thickness T2 of the light exit plane 342 of the second light guide plate 34 is substantially smaller than the first thickness T1 of the light incident plane 321 of the first light guide plate 32, and the second thickness T2 of the light exit plane 342 of the second light guide plate 34 is substantially smaller than the third thickness T3 of the light incident plane 341.

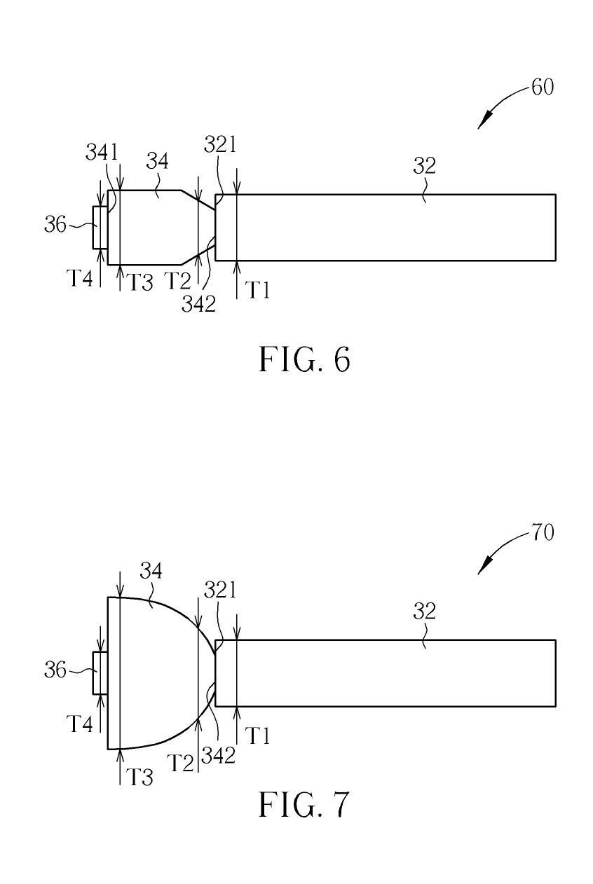

Please refer to FIG. 6, which schematically illustrates an edge lighting back light module according to a fourth preferred embodiment of the present invention. As shown in FIG. 6, in accordance with this embodiment, the cross-section shape of the second light guide plate 34 of the edge lighting back light module 60 is a polygon shape (e.g. a pentagon shape), where the second thickness T2 of the light exit plane 342 of the second light guide plate 34 is substantially smaller than the first thickness T1 of the light incident plane 321 of the first light guide plate 32, and the second thickness T2 of the light exit plane 342 of the second light guide plate 34 may be larger than, smaller than or equal to the third thickness T3 of the light incident plane 341.

Please refer to FIG. 7, which schematically illustrates an edge lighting back light module according to a fifth preferred embodiment of the present invention. As shown in FIG. 7, in accordance with this embodiment, the cross-section shape of the second light guide plate 34 of the edge lighting back light module 70 is a bowl-like shape, where the second thickness T2 of the light exit plane 342 of the second light guide plate 34 is substantially smaller than the first thickness T1 of the light incident plane 321 of the first light guide plate 32, and the second thickness T2 of the light exit plane 342 of the second light guide plate 34 is substantially smaller than the third thickness T3 of the light incident plane 341. Additionally, in a variant configuration of this embodiment, the second light guide plate 34 may be inversely positioned. In other words, on condition that the second thickness T2 of the light exit plane 342 of the second light guide plate 34 is smaller than the first thickness T1 of the light incident plane 321 of the first light guide plate 32, the second thickness T2 of the light exit plane 342 of the second light guide plate 34 may be larger than the third thickness T3 of the light incident plane 341.

According to previous descriptions of the edge lighting back light module of the present invention, as long as the condition that the second thickness T2 of the light exit plane 342 of the second light guide plate 34 is smaller than the first thickness T1 of the light incident plane 321 of the first light guide plate 32 is met, the cross-section shape of the second light guide plate 34 may be modified to a variety of regular or irregular shapes based on designer's discretion.

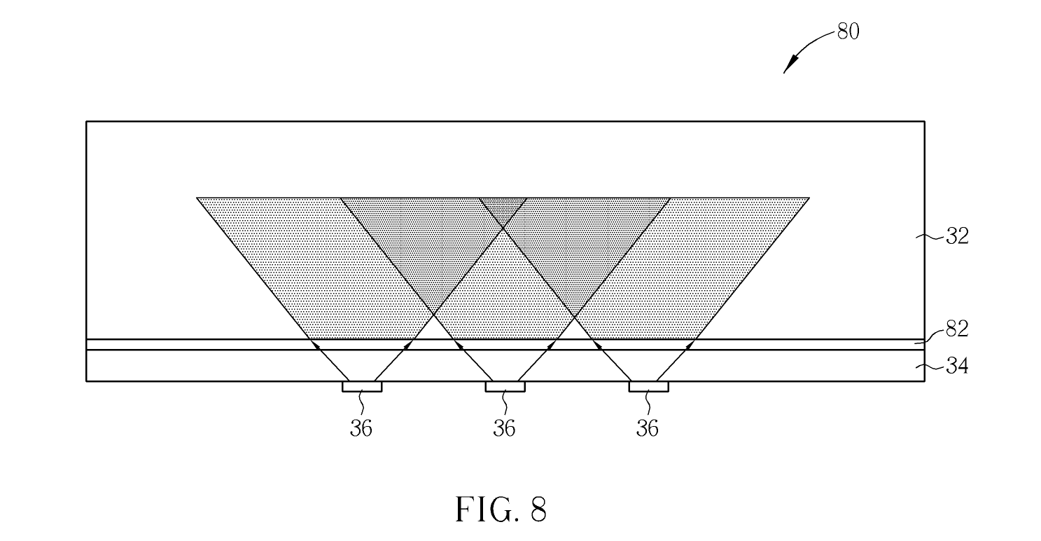

Please refer to FIG. 8, which schematically illustrates an edge lighting back light module according to a sixth preferred embodiment of the present invention. As shown in FIG. 8, in accordance with this embodiment, the edge lighting back light module 80 further includes an optical adhesive 82, disposed between the light incident plane 321 of the first light guide plate 32 and the light exit plane 342 of the second light guide plate 34, to bond the first light guide plate 32 and the second light guide plate 34 together. The refractive index of the optical adhesive 82 preferably lies in between that of the first light guide plate 32 and that of the second light guide plate 34, or equal to that of either the first light guide plate 32 or the second light guide plate 34. For instance, when the refractive index of the first light guide plate 32 is different from that of the second light guide plate 34, the refractive index of the optical adhesive 82 will preferably lie in between the first light guide plate 32 and the second light guide plate 34; on the other hand, when the refractive index of the first light guide plate 32 is the same as that of the second light guide plate 34, the refractive index of the optical adhesive 82 will preferably be identical to that of the first light guide plate 32 and the second light guide plate 34.

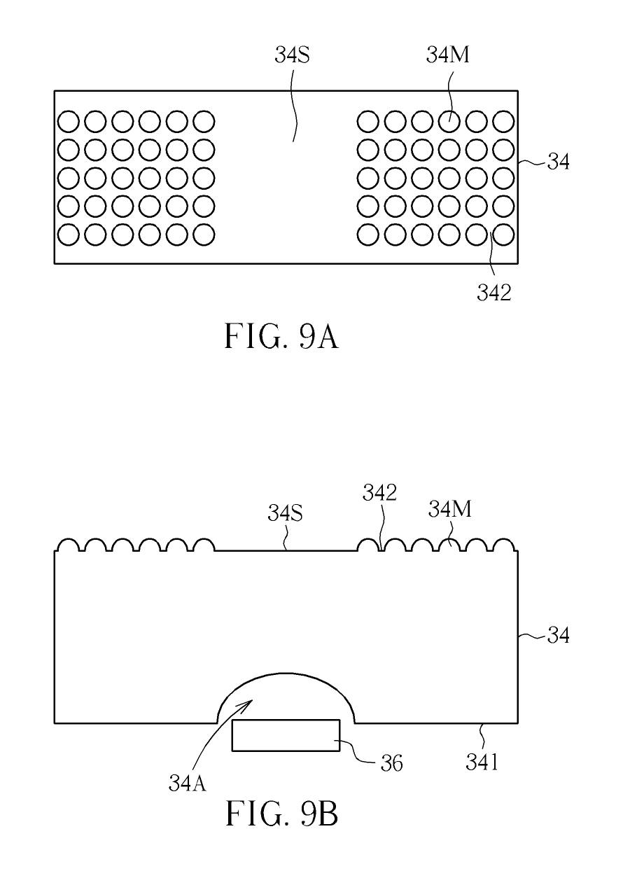

Please refer to FIG. 9A and FIG. 9B, which schematically illustrate a second light guide plate according to a preferred embodiment of the present invention. FIG. 9A is a top view diagram of the second light guide plate, and FIG. 9B is a cross-sectional view diagram of the second light guide plate. As shown in FIG. 9A and FIG. 9B, in accordance with this embodiment, the light incident plane 341 of the second light guide plate 34 has a plurality of first concavities 34A (only one of the first concavities 34A is illustrated) corresponding to each of the light emitting devices 36, respectively. Moreover, the light exit plane 342 of the second light guide plate 34 has a plurality of flat surfaces 34S corresponding to each of the first concavities 34A, respectively. The first concavities 34A are designed for reducing reflection, and thus increasing the incident angle of light entering the light incident plane 341 of the second light guide plate 34. Consequently, the hot spot problem can be avoided. Also, the first concavities 34A may be designed as any shapes. In addition, a plurality of microstructures 34M may be selectively disposed on the light exit plane 342 of the second light guide plate 34 to improve scattering performance of the second light guide plate 34. In other words, the light exit plane 342 of the second light guide plate 34 also could be kept flat without disposing any microstructures. In accordance with this embodiment, each of the microstructures 34M could be a semi-sphere structure or a dot structure. Accordingly, light could be emitted outwardly by virtue of the microstructures 34M.

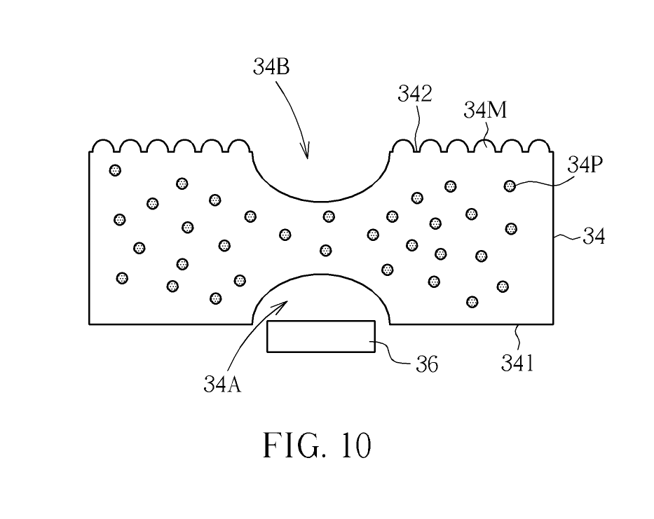

Please refer to FIG. 10, which schematically illustrates a second light guide plate according to another preferred embodiment of the present invention. As shown in FIG. 10, the difference between the present embodiment and the aforementioned embodiment is that a plurality of second concavities 34B can be disposed on the light exit plane 342 of the second light guide plate 34, and the second concavities 34B correspond to each of the first concavities 34A, respectively. The second concavities 34B could be designed as any shapes. Additionally, a plurality of scattering particles 34P could be selectively disposed inside the second light guide plate 34 for the sake of promoting scattering performance of the second light guide plate 34.

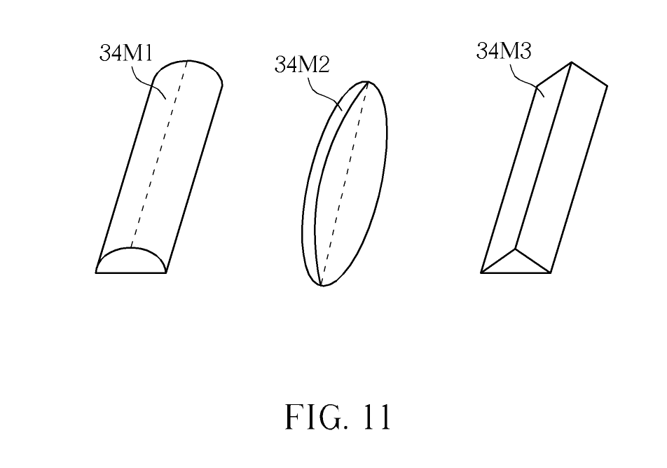

Please refer to FIG. 11, which schematically illustrates microstructures according to a preferred embodiment of the present invention. As shown in FIG. 11, the microstructure 34M, mentioned previously and illustrated in FIG. 9 and FIG. 10, is not limited to a semi-sphere structure or a dot structure, but also could be a semi-cylinder-like structure 34M1, a semi-ellipsoid-like structure 34M2, a prism structure 34M3 or other geometric structure with either regular or irregular conformation.

To sum up, in the edge lighting back light module of the present invention, the thickness of the light exit plane of the second light guide plate is smaller than that of the light incident plane of the first light guide plate, and the light exit plane of the second light guide plate is completely covered within the range of the light incident plane of the first light guide plate. Therefore, the light utilization efficiency can be effectively enhanced. Moreover, the specific designs, such as the first and the second concavities of the second light guide plate, the microstructures and the scattering particles, etc., are capable of promoting light-emitting performance of light sources, and also eliminating the hot spot problem.

Those skilled in the art will readily observe that numerous modifications and alterations of the device and method may be made while retaining the teachings of the invention.

What is claimed is:

1. An edge lighting back light module, comprising:
a first light guide plate, comprising at least one light incident plane, wherein the light incident plane of the first light guide plate has a first thickness;
at least one second light guide plate, comprising a light incident plane and a light exit plane, wherein the light exit plane of the at least one second light guide plate faces the at least one light incident plane of the first light guide plate, the light exit plane of the second light guide plate has a second thickness, and the second thickness of the light exit plane of the second light guide plate is substantially smaller than the first thickness of the light incident plane of the first light guide plate; and
a plurality of light emitting devices, facing the light incident plane of the second light guide plate.

2. The edge lighting back light module according to claim 1, wherein the light incident plane of the second light guide plate has a third thickness.

3. The edge lighting back light module according to claim 2, wherein the third thickness of the light incident plane of the second light guide plate is substantially equal to the second thickness of the light exit plane of the second light guide plate.

4. The edge lighting back light module according to claim 2, wherein the third thickness of the light incident plane of the second light guide plate is substantially smaller than the second thickness of the light exit plane of the second light guide plate.

5. The edge lighting back light module according to claim 2, wherein the third thickness of the light incident plane of the second light guide plate is substantially larger than the second thickness of the light exit plane of the second light guide plate.

6. The edge lighting back light module according to claim 2, wherein each of the light emitting devices has a light exit plane, the light exit plane of the light emitting device has a fourth thickness, and the fourth thickness of the light exit plane of the light emitting device is substantially smaller than or equal to the third thickness of the light incident plane of the second light guide plate.

7. The edge lighting back light module according to claim 1, wherein a cross-section shape of the second light guide plate includes a rectangle shape, a trapezoid shape, a bowl-like shape or a polygon shape.

8. The edge lighting back light module according to claim 1, wherein the light incident plane of the second light guide plate has a plurality of first concavities corresponding to each of the light emitting devices, respectively.

9. The edge lighting back light module according to claim 8, wherein the light exit plane of the second light guide plate has a plurality of second concavities corresponding to each of the first concavities, respectively.

10. The edge lighting back light module according to claim 8, wherein the light exit plane of the second light guide plate has a plurality of flat surfaces corresponding to each of the first concavities, respectively.

11. The edge lighting back light module according to claim 8, wherein the light exit plane of the second light guide plate has a plurality of microstructures.

12. The edge lighting back light module according to claim 11, wherein each of the microstructures includes a semi-sphere structure, a semi-cylinder-like structure, a semi-ellipsoid-like structure or a prism structure.

13. The edge lighting back light module according to claim 1, further comprising a plurality of scattering particles, disposed inside the second light guide plate.

14. The edge lighting back light module according to claim 1, wherein each of the light emitting devices comprises an LED device.

15. The edge lighting back light module according to claim 1, wherein the light incident plane of the first light guide plate contacts with the light exit plane of the second light guide plate.

16. The edge lighting back light module according to claim 1, further comprising an optical adhesive, disposed between the light incident plane of the first light guide plate and the light exit plane of the second light guide plate for bonding the first light guide plate and the second light guide plate.
